(19) United States
(12) Patent Application Publication
(10) Pub. No.: US 2007/0049330 A1
(43) Pub. Date: Mar. 1, 2007

(54) Wireless transceiver for supporting a plurality of communication or broadcasting services

(75) Inventors: Dae-yeon Kim, Suwon-si (KR); Ju-ho Son, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/480,503

(22) Filed: Jul. 5, 2006

(30) Foreign Application Priority Data
Aug. 25, 2005 (KR) 10-2005-0078322

(51) Int. Cl. H04M 1/00

(52) U.S. Cl. 455/552.1

(57) ABSTRACT

A wireless transceiver for receiving and processing a wireless local area network (WLAN) radio frequency (RF) signal and a satellite Digital Multimedia Broadcasting (DMB) RF signal, and generating and transmitting a WLAN RF signal, is provided. The wireless transceiver includes a reception antenna for receiving the WLAN RF signal or the satellite DMB RF signal; a quadrature demodulator for down-converting the received signal into a baseband signal, based on a local oscillator signal, and providing the baseband signal to a baseband processor; and a local oscillator signal generation unit which is configured to generate the local oscillator signal according to whether the received signal is a WLAN RF signal or a satellite DMB RF signal.

### CROSS-REFERENCE TO RELATED APPLICATION

This application claims priority from Korean Patent Application No. 10-2005-0078322 filed on Aug. 25, 2005 in the Korean Intellectual Property Office, the disclosure of which is incorporated herein by reference in its entirety.

### BACKGROUND OF THE INVENTION

1. Field of the Invention

The present invention relates to transceivers for wireless communication and, more particularly, to a radio frequency integrated circuit architecture, in which a radio frequency integrated circuit for a wireless local area network (WLAN) and a radio frequency integrated circuit for satellite digital multimedia broadcasting (DMB) are integrated.

2. Description of the Related Art

Generally, it is well known that wireless (or radio) communication is conducted terrestrially in such a way that at the transmitting end information (baseband) signals are up-converted and superimposed into electromagnetic waves having predetermined frequencies to be down-converted and filtered at the receiving end to obtain the baseband signals. Since wireless communication is conducted through radio waves, usable frequency bands are limited, and a method of propagating radio waves typically varies according to the frequency of radio waves. In a high frequency band, since radio waves are propagated terrestrially, in each country throughout the world, the frequency bands used for channels are regulated to prevent interferences from occurring. Wireless communication technology is generally sub-classified into fixed communication technology, mobile communication technology and satellite communication technology, based on the mobility, technical scheme or the purpose of each system.

Unlike wired communication technology, wireless communication technology is spatially or temporally limited with respect to its usable frequency spectrum, thus the efficient usage of spectrum is an important issue in terms of preventing communication interferences from occurring between users and of maintaining suitable transmission quality. Research in the wireless communication technology has been progressing in three areas, that is, developing technologies implementing a new frequency band, improving the operating efficiency by narrowing or sharing the existing frequency bands, and developing technologies for new services.

Technology for manufacturing wireless communication devices has been continuously directed toward realizing smaller and lighter devices and devices having low-power consumption. To this end, devices employing semiconductor devices or filters have been developed. Further, a technology for designing circuits including a radio frequency integrated circuit (RFIC), a surface mount technology (SMT), and a technology for developing high-capacity batteries have thus far been implemented. In addition, communication modes have been gradually changed from an analog mode to a digital mode, and in the content service industry, non-voice services using data, messages, facsimile, images, etc., as well as voice, have rapidly expanded.

Currently, a direct-conversion transmission/reception mode has been adopted in the Institute of Electrical & Electronics Engineers (IEEE) 802.11 standards related to wireless local area network (LAN) communication. Such a mode directly converts a radio frequency into a baseband frequency without converting the radio frequency into an intermediate frequency (IF), thus it is advantageous in that the number of RF devices (such as a down mixer, a surface acoustic wave (SAW) filter, etc.) can be reduced, and low manufacturing cost in addition to low-power consumption can be realized by implementing RF on-chip.

A conventional wireless transceiver implemented with the IEEE 802.11 standards has been designed so that a direct-conversion RFIC for wireless communication is mounted therein to process signals in a 5 GHz to 6 GHz frequency band. However, since current satellite Digital Multimedia Broadcasting (DMB) standards require wireless devices to use a 2.6 GHz frequency band, RFICs for satellite DMB has also been designed to process signals in the 2.6 GHz frequency band.

A conventional transmission/reception system 10 for wireless LAN (WLAN) is shown in FIG. 1. Referring to FIG. 1, the WLAN system 10 includes a reception unit and a transmission unit. The reception unit includes a reception antenna 1, a low-noise amplifier (LNA) 2, a quadrature demodulator 3, a filter 4, an amplifier 5, and an analog-to-digital converter (ADC) 6. The transmission unit includes a digital-to-analog converter (DAC) 16, an amplifier 15, a filter 14, a quadrature modulator 13, a power amplifier 12, and a transmission antenna 11.

The reception unit receives an RF signal through the reception antenna 1, and outputs a reception (Rx) signal through the ADC 6. In contrast, in the transmission unit, a transmission (Tx) signal input to the DAC 16 is transmitted as an RF signal through the transmission antenna 11.

In the operation of the transmission unit and the reception unit, local oscillator signals, provided to the quadrature demodulator 3 and the quadrature modulator 13, are generated by a voltage controlled oscillator (VCO) 8, and are prevented from fluctuating by a phase locked loop (PLL) 7.

A block configuration of the WLAN transmission/reception system 10 can also be applied to a receiver implemented with the satellite DMB standards, except that the frequency band of the received RF signal varies, and, unlike the system 10, the receiver does not have a transmission module.

Therefore, in the conventional technology, since an RFIC for WLAN and an RFIC configured for the satellite DMB standards are separately provided, it is not possible to simultaneously receive both network communication and satellite broadcasting services using a single RFIC. That is, it is not possible to watch satellite broadcasting TV programs using an RFIC for a WLAN and to use WLAN service using the RFIC configured for the satellite DMB standards.

However, if an RFIC for WLAN and an RFIC configured for the satellite DMB standards are mounted together in a single system to simultaneously support both WLAN and satellite DMB services, there is a drawback in that the manufacturing cost and the size of a system employing the two RFICs are inevitably increased.

### SUMMARY OF THE INVENTION

Accordingly, apparatuses consistent with the present invention have been made in order to address the above and other problems occurring in the prior art, and an object of the present invention is to provide a technology that integrates RFICs having different functionalities to support both multimedia broadcasting and network communication services.

Another object of the present invention is to provide an RFIC system architecture employing an existing RFIC for WLAN, which can be implemented in a receiver configured for the satellite DMB standards.

In order to accomplish the above and other objects, a wireless transceiver for receiving and processing a wireless local area network (WLAN) radio frequency (RF) signal and a satellite Digital Multimedia Broadcasting (DMB) RF signal, and generating and transmitting a WLAN RF signal is provided. The wireless transceiver includes a reception antenna for receiving the WLAN RF signal or the satellite DMB RF signal; a quadrature demodulator for down-converting the received signal into a baseband signal based on a local oscillator signal, and providing the baseband signal to a baseband processor; and a local oscillator signal generation unit which is configured to generate a local oscillator signal according to whether the received signal is a WLAN RF signal or a satellite DMB RF signal.

According to an exemplary embodiment of the present invention, the local oscillator signal generation unit may include a voltage controlled oscillator (VCO) for generating a signal resonating at ½ of a frequency of the WLAN RF signal; a phase locked loop (PLL) for receiving feedback of the generated signal and locking a phase of the generated signal; a frequency multiplier for multiplying the frequency of the generated signal generated by 2 if the WLAN RF signal has been received through the reception antenna; a first phase generator for generating the local oscillator signal, based on a signal provided from the frequency multiplier, and for providing the local oscillator signal to the quadrature demodulator; and a second phase generator for generating a local oscillator signal, based on the signal generated by the VCO, and for providing the local oscillator signal to the quadrature demodulator if the satellite DMB RF signal has been received through the reception antenna. Moreover, at least one switch may switch between a signal path connecting the VCO and the quadrature demodulator through the frequency multiplier and the first phase generator, and a signal path connecting the VCO and the quadrature demodulator through the second phase generator.

According to another exemplary embodiment of the present invention, the local oscillator signal generation unit may include a VCO for generating a signal resonating at the frequency of the WLAN RF signal; a PLL for receiving feedback of the generated signal and locking a phase of the generated signal; a first phase generator for generating a local oscillator signal based on the generated signal and for providing the local oscillator signal to the quadrature demodulator if the WLAN RF signal has been received through the reception antenna; a frequency divider for dividing the frequency of the signal generated by the VCO by 2 if the satellite DMB RF signal has been received through the reception antenna; and a second phase generator for generating the local oscillator signal based on a signal output from the frequency divider and for providing the local oscillator signal to the quadrature demodulator. At least one switch may switch between a signal path connecting the VCO and the quadrature demodulator through the first phase generator, and a signal path connecting the VCO to the quadrature demodulator through the frequency divider and the second phase generator, may be switched over by one or more switches.

According to a further exemplary embodiment of the present invention, the local oscillator signal generation unit may include a VCO for generating at least two quadrature local oscillator signals resonating at a frequency of the WLAN RF signal; a PLL for receiving feedback of each of the generated signals and locking the phase of the generated signals; a buffer for controlling a gain or delay of each of the generated signals and for providing the controlled signal to the quadrature demodulator if the WLAN RF signal has been received through the reception antenna; and a frequency divider for dividing the frequency of each of the signals generated by the VCO by 2 and for providing the frequency-divided signals to the quadrature demodulator if the satellite DMB RF signal has been received through the reception antenna. At least one switch may switch between a signal path connecting the VCO and the quadrature demodulator through the buffer, and a signal path connecting the VCO and the quadrature demodulator through the frequency divider.

### BRIEF DESCRIPTION OF THE DRAWINGS

The above and other aspects of the present invention will be more clearly understood from the following detailed description taken in conjunction with the accompanying drawings, in which:

FIG. 1 is a block diagram of a conventional WLAN transmission/reception system;

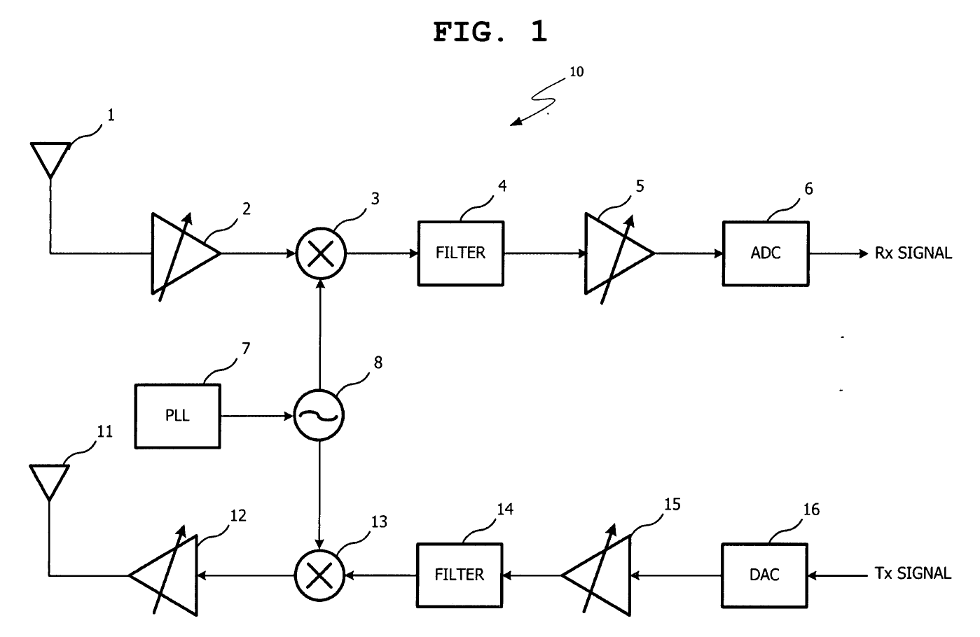

FIG. 2 is a block diagram showing the construction of a wireless transceiver, according to an exemplary embodiment of the present invention;

FIG. 3 is a block diagram showing the detailed construction of a phase generator, a quadrature modulator and a quadrature demodulator, according to an exemplary embodiment of the present invention;

FIG. 4 is a block diagram showing the construction of a wireless transceiver, according to another exemplary embodiment of the present invention; and

FIG. 5 is a block diagram showing the construction of a wireless transceiver, according to a further exemplary embodiment of the present invention.

### DESCRIPTION OF EXEMPLARY EMBODIMENTS OF THE PRESENT INVENTION

Reference now will be made to the drawings, in which the same reference numerals are used throughout the different drawings to designate the same or similar components.

Hereinafter, exemplary embodiments of the present invention will be described in detail with reference to the attached drawings.

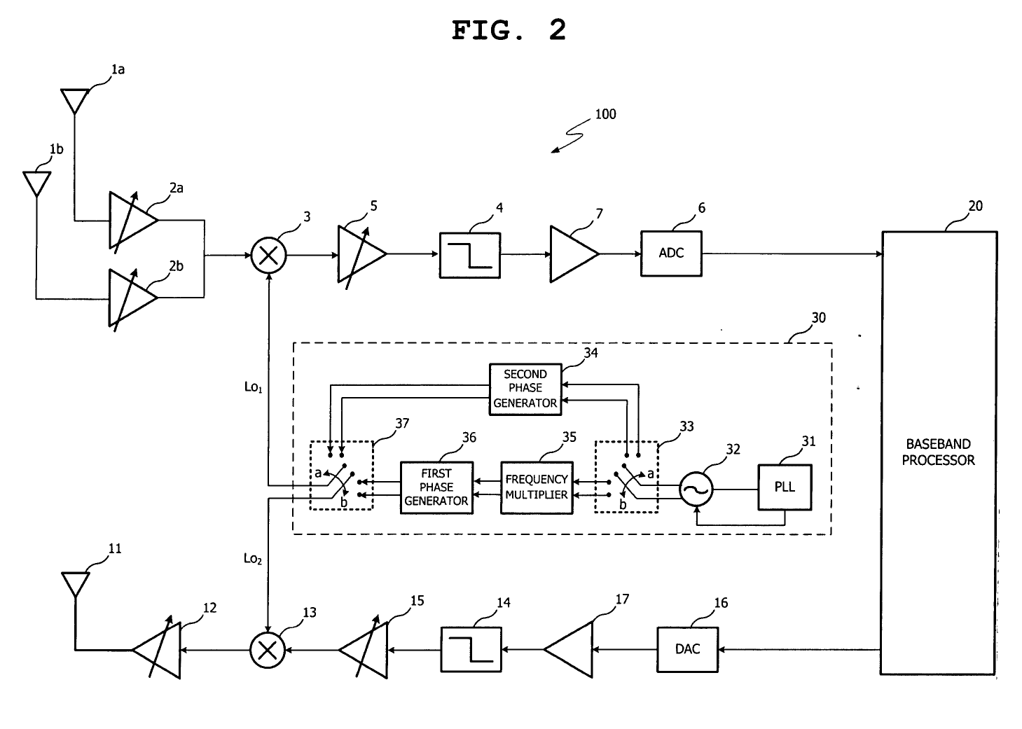

FIG. 2 is a block diagram showing the construction of a wireless transceiver 100, according to an exemplary embodiment of the present invention. The wireless transceiver 100 is designed by providing sub-blocks, which may be predetermined, to the construction of an existing radio frequency integrated circuit (RFIC) for wireless local area network (WLAN) or by modifying existing sub-blocks. That is, the wireless transceiver is designed for satellite Digital Multimedia Broadcasting (DMB) standards while maintaining the function of the wireless transceiver for WLAN.

The wireless transceiver 100 includes two reception antennas, a first reception antenna 1A and a second reception antenna 1B and two low-noise amplifiers (LNAs), a first LNA 2A and a second LNA 2B. The first reception antenna 1A and the first LNA 2A receive a WLAN radio frequency (RF) signal, and the second reception antenna 1B and the second LNA 2B receive a satellite DMB RF signal. However, the above construction having a plurality of reception antennas and a plurality of LNAs is only an example. As another example, the antennas and the LNAs can be replaced with a single wideband antenna and a single wideband LNA capable of simultaneously receiving and amplifying a WLAN RF signal and a satellite DMB RF signal.

The WLAN RF signal is input to the first reception antenna 1A and is amplified by the first LNA 2A. The amplified RF signal is input to a quadrature demodulator 3. Similarly, the satellite DMB RF signal is input to the second reception antenna 1B and is amplified by the second LNA 2B. The amplified RF signal is input to the quadrature demodulator 3.

The quadrature demodulator 3 down-converts the received RF signal (the WLAN RF signal or the satellite DMB RF signal) into a baseband signal. For this operation, a local oscillator signal Lₒ₁ of the system must be multiplied by the input RF signal.

The local oscillator signal is generated by a local oscillator signal generation unit 30. The local oscillator signal generation unit 30 will be described in detail later.

The baseband signal obtained by the quadrature demodulator 3 is input to a variable gain amplifier (VGA) 5. The VGA 5 amplifies the received baseband signal using automatic-gain control (AGC). The VGA 5 can control the gain in a range somewhat wider than that of the first LNA 2A and the second LNA 2B. As the VGA 5, a single VGA or a plurality of VGAs can be used. For example, if a gain of 40 dB must be increased by the VGA, the gain can be controlled by employing a single VGA 5 and causing the VGA to take charge of 40 dB, or by employing two VGAs (not shown) and causing each VGA to take charge of 20 dB. If a plurality of VGAs is employed, some VGAs may be provided before a low-pass filter (LPF) 4, and other VGAs may be provided after the LPF 4.

The LPF 4 performs low-pass filtering on the signal provided from the VGA 5. This filtering operation extracts a frequency band corresponding to that of the data signal from the received signal.

An output buffer 7 adjusts the level and delay of a signal provided from the LPF 4, and provides an analog signal corresponding to the adjustment to an analog-to-digital converter (ADC) 6. The ADC 6 converts the analog signal into a digital signal, and provides the digital signal to a baseband processor 20.

The baseband processor 20 processes the digital signal and outputs the processed digital signal to, for example, a medium access control (MAC) layer module. The digital signal may be one of a digital signal based on a WLAN RF signal and a digital signal based on a satellite DMB RF signal.

When the wireless transceiver 100 transmits the WLAN RF signal, the baseband processor 20 processes data for WLAN and transmits the processed data to a digital-to-analog converter (DAC) 16.

The DAC 16 converts the digital data provided from the baseband processor 20 into an analog signal. Further, a buffer 17 adjusts the level and delay of the analog signal so that the signal provided from the DAC 16 can be input to an LPF 14.

The LPF 14 performs low-pass filtering on the input signal, and extracts only a frequency band of data signal. A variable gain amplifier (VGA) 15 amplifies a signal output from the LPF 14 using automatic gain control. The VGA 15 may be implemented using a plurality of VGAs.

A quadrature modulator 13 multiplies the signal input from the VGA 15 by a local oscillator signal Lₒ₂, thus up-converting the frequency band of the input signal into a frequency band of a WLAN RF signal to be transmitted. The local oscillator signal Lₒ₂ is also provided by the local oscillator signal generation unit 30.

A power amplifier 12 amplifies the power of the signal provided from the quadrature modulator 13. The amplified signal is transmitted through the transmission antenna 11.

The local oscillator signal generation unit 30 includes a first switch 33, a second switch 37, first and second phase generators 36 and 34, a frequency multiplier 35, a voltage controlled oscillator (VCO) 32 and a phase locked loop (PLL) 31.

Radio frequencies for WLAN and satellite DMB are described below. The frequency band of a WLAN RF signal is usually in a range of about 4.9 GHz to about 5.9 GHz, and the frequency band of a satellite DMB RF signal is usually in a range of about 2.6 GHz to about 2.655 GHz. Therefore, ½ of a center frequency of the WLAN RF signal is similar to a center frequency of the satellite DMB RF signal. Further, the baseband frequencies of WLAN and satellite DMB are usually 8.3 MHz and 8.242 MHz, respectively, which are close to each other. Using these characteristics, the simultaneous reception of a WLAN RF signal and a satellite DMB RF signal using a single RFIC may be achieved.

The VCO 32 causes the frequency of a signal generated thereby to resonate at ½ of the frequency of the WLAN RF signal. In this case, the VCO 32 is designed so that the tuning range is in a range of about 2.45 GHz to about 2.95 GHz. The tuning range includes the frequency range of the satellite DMB RF signal. If the tuning range is increased by twice, the increased range is in a frequency band of about 4.9 GHz to about 5.9 GHz, which is the frequency range of the WLAN RF signal.

The PLL 31 receives the feedback of the signal generated by the VCO 32 and locks the phase of the generated signal, thus preventing the generated signal from fluctuating.

If a WLAN RF signal is input to the quadrature demodulator 3, both the first switch 33 and the second switch 37 are switched over to location “b”. In this case, the frequency multiplier 35 multiplies the frequency of the signal generated by the VCO 32 by 2. For this operation, the frequency multiplier 35 can be implemented using a scheme of matching the output of the VCO 32 to intended harmonic frequencies using the non-linear characteristics of a non-linear device.

The first phase generator 36 generates quadrature local oscillator signals Lₒ₁ and Lₒ₂ based on the signal provided from the frequency multiplier 35, and provides the quadrature local oscillator signals Lₒ₁ and Lₒ₂ to the quadrature demodulator 3 and the quadrature modulator 13, respectively.

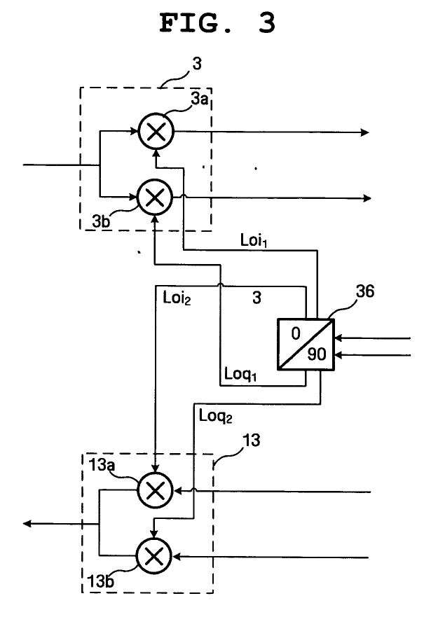

The operation of the first phase generator 36 is described in detail with reference to FIG. 3. The local oscillator signal Lₒ₁, provided by the first phase generator 36 to the quadrature demodulator 3, is actually composed of two signals Loi₁ and Loq₁. The signals Loi₁ and Loq₁ generated by the first phase generator 36 have a phase difference of 90° therebetween. The quadrature demodulator 3 is constructed to have a separated part 3a for receiving the signal Loi₁ and a separated part 3b for receiving the signal Loq₁.

Similar to this, the local oscillator signal Lₒ₂, provided by the first phase generator 36 to the quadrature modulator 13, is actually composed of two signals Loi₂ and Loq₂. The signals Loi₂ and Loq₂, generated by the first phase generator 36, also have a phase difference of 90° therebetween. The quadrature demodulator 13 is also constructed to have a separated part 13a for receiving the signal Loi₂ and a separated part 13b for receiving the signal Loq₂.

Referring to FIG. 2 again, if a satellite DMB RF signal is input to the quadrature demodulator 3, both the first switch 33 and second switch 37 are switched over to location “a”. Therefore, the signal generated by the VCO 32 is input to the second phase generator 34, without passing through the frequency multiplier 35.

The second phase generator 34 has a construction similar to that of the first phase generator 36, and outputs quadrature local oscillator signals having a phase difference of 90° therebetween. The local oscillator signals constitute the signal Lo₁, which is input to the quadrature demodulator 3.

The switching operation of the switches 33 and 37 may be controlled by a digital interface (not shown) provided in the wireless transceiver 100, or by another similar interface known in the art.

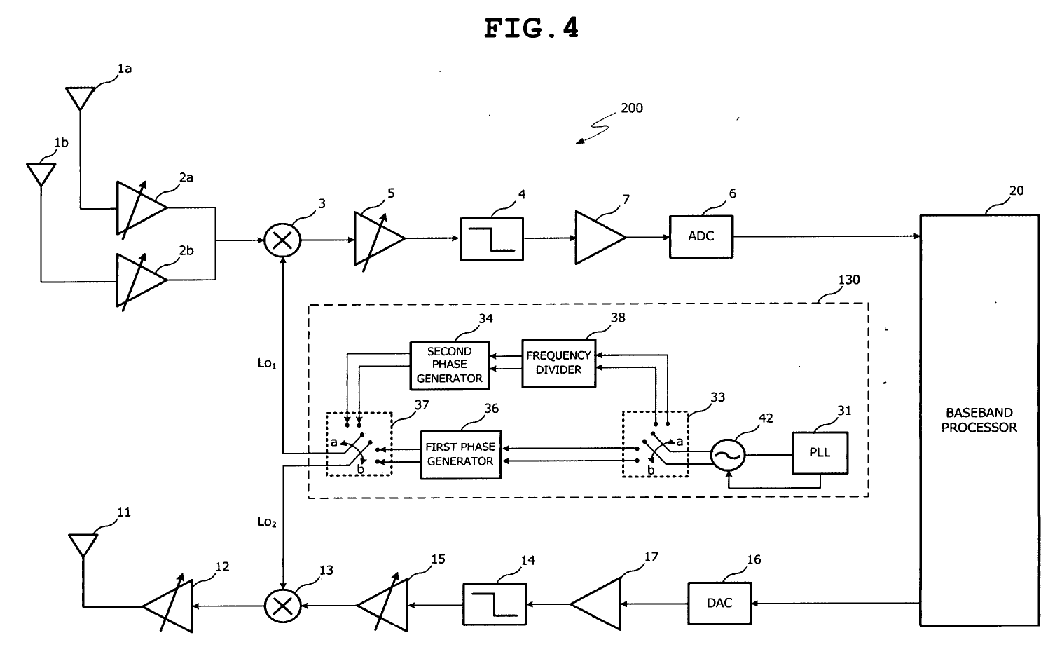

FIG. 4 is a block diagram showing the construction of a wireless transceiver 200 according to another exemplary embodiment of the present invention. In the construction of the wireless transceiver 200, components other than a local oscillator signal generation unit 130 are the same as those of the wireless transceiver 100 of FIG. 2, thus a repetitive description thereof will be omitted, and description will be mainly provided based on the construction of the local oscillator signal generation unit 130.

A VCO 42 causes the frequency of a signal generated thereby to resonate at the frequency of a WLAN RF signal. In this case, the VCO 42 is designed so that the tuning range thereof is in a band of about 4.5 GHz to about 5.9 GHz. If the tuning range is divided by 2, the divided tuning range includes the frequency range of a satellite DMB RF signal.

A PLL 31 receives the feedback of the signal generated by the VCO 42 and locks the phase of the generated signal, thus preventing the generated signal from fluctuating.

If a WLAN RF signal is input to a quadrature demodulator 3, a first switch 33 and a second switch 37 are switched over to location “b”. In this case, a first phase generator 36 generates local oscillator signals Lo₁ and Lo₂ based on the signal provided from the VCO 42, and provides the local oscillator signals Lo₁ and Lo₂ to the quadrature demodulator 3 and the quadrature modulator 13, respectively. Each local oscillator signal may be composed of two quadrature local oscillator signals.

If a satellite DMB RF signal is input to the quadrature demodulator 3, both the first switch 33 and the second switch 37 are switched over to location “a”. In this case, a frequency divider 38 divides the frequency of the signal, generated by the VCO 42, by 2. For this operation, the frequency divider 38 can be implemented using a scheme of matching the output of the VCO 42 to intended harmonic frequencies using the non-linear characteristics of a non-linear device. Similar to the first phase generator 36, the second phase generator 34 outputs quadrature local oscillator signals having a phase difference of 90° therebetween.

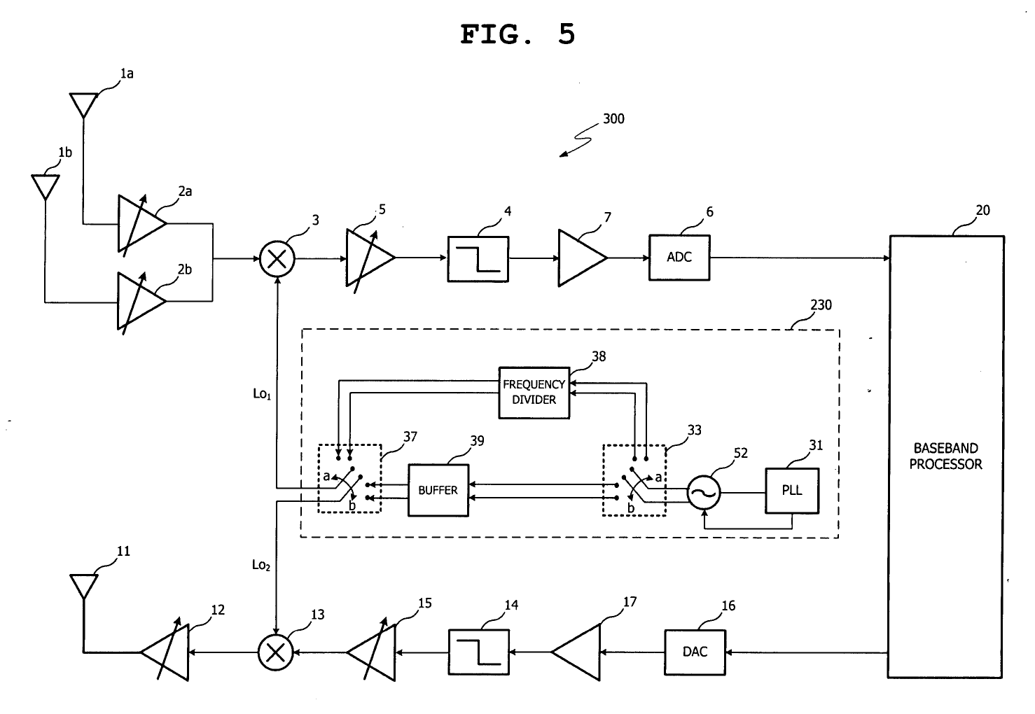

FIG. 5 is a block diagram showing the construction of a wireless transceiver 300 according to a further exemplary embodiment of the present invention. In the construction of the wireless transceiver 300, components other than a local oscillator signal generation unit 230 are the same as those of the wireless transceiver 200 of FIG. 4, thus a repetitive description thereof will be omitted, and description will be provided based on the construction of the local oscillator signal generation unit 230.

A VCO 52 directly generates quadrature local oscillator signals unlike the VCO 42 of FIG. 4. The tuning range of the VCO 52 is set to a frequency band of about 4.5 GHz to about 5.9 GHz, similar to the VCO 42 of FIG. 4.

If a WLAN RF signal is input to a quadrature demodulator 3, both a first switch 33 and a second switch 37 are switched over to location “b”. In this case, a buffer 39 adjusts the gain and/or delay of the signal provided from the VCO 52, and provides the adjusted signal to the second switch 37.

If a satellite DMB RF signal is input to the quadrature demodulator 3, both the first switch 33 and the second switch 37 are switched over to location “a”. In this case, the frequency divider 38 divides the frequency of the signal, generated by the VCO 52, by 2.

In FIG. 5, the VCO 52 generates two quadrature local oscillator signals having a phase difference of 90° therebetween, so that each signal line indicated in the local oscillator signal generation unit 230 is actually implemented using two signal lines.

The components related to exemplary embodiments of FIGS. 2 to 5 are implemented or executed using devices, such as a general-purpose processor, a digital signal processor (DSP), an application-specific integrated circuit (ASIC), a field programmable gate-array (FPGA) or other programmable logic devices, a discrete gate or transistor logic device, or discrete hardware components, or arbitrary combinations thereof. The general-purpose processor may be a microprocessor, and alternatively may be an arbitrary conventional processor, controller, microcontroller or state machine. The processor may be implemented using a combination of computing devices, for example, a combination of a DSP with a microprocessor, a combination of a plurality of microprocessors, or a combination of one or more DSP core-related microprocessors or other related components.

As described above, apparatuses consistent with the present invention provide a wireless transceiver, which can receive both RF signals for WLAN service and RF signals for satellite DMB using a single RFIC.

Therefore, apparatuses consistent with the present invention are advantageous in that they may provide both types of services using a single RFIC unlike a conventional transceiver, thus eventually decreasing the manufacturing cost of wireless transceivers.

Although certain exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless transceiver for receiving and processing a wireless local area network (WLAN) radio frequency (RF) signal and a satellite Digital Multimedia Broadcasting (DMB) RF signal, and generating and transmitting a WLAN RF signal, the wireless transceiver comprising:
a reception antenna for receiving the WLAN RF signal or the satellite DMB RF signal;
a quadrature demodulator for down-converting the received signal into a baseband signal, based on a local oscillator signal, and providing the baseband signal to a baseband processor; and
a local oscillator signal generation unit which is configured to generate the local oscillator signal according to whether the received signal is a WLAN RF signal or a satellite DMB RF signal.

2. The wireless transceiver according to claim 1, further comprising:
a quadrature modulator for up-converting a frequency band of a signal provided from the baseband processor into a frequency band of a WLAN RF signal to be transmitted as the up-converted signal; and
a transmission antenna for transmitting the up-converted signal.

3. The wireless transceiver according to claim 1, further comprising:
a low-noise amplifier (LNA) for amplifying the RF signal received through the reception antenna;
a variable gain amplifier (VGA) for controlling a gain of the down-converted baseband signal using automatic gain control;
a low-pass filter (LPF) for performing low-pass filtering on the gain-controlled signal; and
an analog-to-digital converter (ADC) for converting the low-pass filtered signal into a digital signal.

4. The wireless transceiver according to claim 2, further comprising:
a digital-to-analog converter (DAC) for converting the signal provided from the baseband processor into an analog signal;
a low-pass filter (LPF) for performing low-pass filtering on the analog signal;
a variable gain amplifier (VGA) for controlling a gain of the low-pass filtered signal using automatic gain control and for providing the gain-controlled signal to the quadrature modulator; and
a power amplifier for amplifying the signal up-converted by the quadrature modulator and for providing the amplified signal to the transmission antenna.

5. The wireless transceiver according to claim 1, wherein the WLAN RF signal is in a frequency band of about 4.5 GHz to about 5.9 GHz.

6. The wireless transceiver according to claim 5, wherein the satellite DMB RF signal is in a frequency band of about 2.6 GHz to about 2.655 GHz.

7. The wireless transceiver according to claim 1, wherein the local oscillator signal generation unit comprises:
a voltage controlled oscillator (VCO) for generating a signal resonating at ½ of a frequency of the WLAN RF signal;
a phase locked loop (PLL) for receiving feedback of the generated signal and locking a phase of the generated signal;
a frequency multiplier for multiplying the frequency of the signal generated by the VCO by 2 if the WLAN RF signal has been received through the reception antenna;
a first phase generator for generating the local oscillator signal, based on a signal provided from the frequency multiplier, and for providing the local oscillator signal to the quadrature demodulator; and
a second phase generator for generating the local oscillator signal, based on the signal generated by the VCO and for providing the local oscillator signal to the quadrature demodulator, if the satellite DMB RF signal has been received through the reception antenna.

8. The wireless transceiver according to claim 7, wherein at least one switch switches between a signal path connecting the VCO and the quadrature demodulator through the frequency multiplier and the first phase generator, and a signal path connecting the VCO and the quadrature demodulator through the second phase generator.

9. The wireless transceiver according to claim 8, wherein the VCO has a tuning range in a frequency band of about 2.45 GHz to about 2.95 GHz.

10. The wireless transceiver according to claim 7, wherein the frequency multiplier is implemented by harmonic frequency matching.

11. The wireless transceiver according to claim 7, wherein the local oscillator signal comprises two quadrature local oscillator signals having orthogonal phases.

12. The wireless transceiver according to claim 1, wherein the local oscillator signal generation unit comprises:
a VCO for generating a signal resonating at a frequency of the WLAN RF signal;
a PLL for receiving feedback of the generated signal and locking a phase of the generated signal;
a first phase generator for generating a local oscillator signal based on the generated signal and for providing the local oscillator signal to the quadrature demodulator if the WLAN RF signal has been received through the reception antenna;
a frequency divider for dividing the frequency of the signal generated by the VCO by 2 if the satellite DMB RF signal has been received through the reception antenna; and
a second phase generator for generating the local oscillator signal based on a signal output from the frequency divider and for providing the local oscillator signal to the quadrature demodulator.

13. The wireless transceiver according to claim 12, wherein at least one switch switches between a signal path connecting the VCO and the quadrature demodulator through the first phase generator, and a signal path connecting the VCO and the quadrature demodulator through the frequency divider and the second phase generator.

14. The wireless transceiver according to claim 12, wherein the VCO has a tuning range in a frequency band of about 4.5 GHz to about 5.9 GHz.

15. The wireless transceiver according to claim 11, wherein the local oscillator signal comprises two quadrature local oscillator signals having orthogonal phases.

16. The wireless transceiver according to claim 1, wherein the local oscillator signal generation unit comprises:
a VCO for generating at least two quadrature local oscillator signals resonating at a frequency of the WLAN RF signal;
a PLL for receiving feedback of each of the generated signals and locking the phase of each of the generated signals;
a buffer for controlling a gain or delay of each of the generated signals and for providing the controlled signals to the quadrature demodulator if the WLAN RF signal has been received through the reception antenna; and
a frequency divider for dividing the frequency of each of the signals generated by the VCO by 2 and for providing the frequency-divided signals to the quadrature demodulator if the satellite DMB RF signal has been received through the reception antenna.

17. The wireless transceiver according to claim 16, wherein at least one switch switches between a signal path connecting the VCO to the quadrature demodulator through the buffer, and a signal path connecting the VCO and the quadrature demodulator through the frequency divider.

18. The wireless transceiver according to claim 15, wherein each of the at least two quadrature local oscillator signals comprises two quadrature local oscillator signals having orthogonal phases.
